(19) United States
(12) Patent Application Publication
(10) Pub. No.: US 2022/0337927 A1
(43) Pub. Date: Oct. 20, 2022

(54) Metamaterial To Scale Down Loudspeaker Enclosure Size And Enhance Performance

(71) Applicant: Plantronics, Inc., Santa Cruz, CA (US)

(72) Inventors: Wayne Stanley FOLETTA, San Martin, CA (US); Steven L. POTTS, Andover, MA (US)

(73) Assignee: Plantronics, Inc., Santa Cruz, CA (US)

(21) Appl. No.: 17/327,219

(22) Filed: May 21, 2021

Related U.S. Application Data
(60) Provisional application No. 63/176,655, filed on Apr. 19, 2021.

(51) Int. Cl. H04R 1/02; H04R 1/22

(52) U.S. Cl. CPC H04R 1/02; H04R 1/22

(57) ABSTRACT

A system includes a speaker enclosure, a speaker in the speaker enclosure, and a meta cell. The meta cell includes an opening on a first end connected to the speaker enclosure, and a closed cavity on a second end.

### PRIORITY

This application claims priority to U.S. Provisional Application No. 63/176,655 filed Apr. 19, 2021, the contents of which are hereby incorporated in their entirety.

### FIELD OF THE INVENTION

The present disclosure relates to loudspeakers and speakers and, more particularly, to a metamaterial to scale down loudspeaker enclosure size and enhance performance.

### BACKGROUND

The conventional loudspeaker enclosure design is to eliminate sound that radiates from the back side of the driver diaphragm and is trapped in a rear enclosure. If that sound is not absorbed, it reflects from the interior components and walls of the box and can radiate out through the diaphragm of the driver. Sound can also radiate sound through the walls of the enclosure. When the sound emerges from the box, it mixes with the sound radiated by the driver diaphragm front. This causes a degradation of the low frequency response.

A speaker may have a speaker or driver suspension. The suspension may be a surround elastomer ring at the top of a diaphragm or cone and the spider support of a speaker at the voice coil. Together, the suspension and support position the moving parts of the speaker that are aligned with an air gap of magnet pole pieces of the speaker. The suspension floats the moving parts preventing them from contacting the fixed components.

A conventional speaker enclosure has an air volume of two times or more the speaker Vas for the best available acoustic performance. Vas may be the equivalent compliance volume. Speaker compliance may be a measure of the inverse of suspension stiffness. The more compliant a suspension system is, the lower its stiffness or resistant to motion. Stiffness may be a measure of the suspension of a given speaker, including a surround and a spider of the speaker. The diaphragm of a speaker may move when the speaker is generating sound. Thus, the Vas may be a measure of how much air volume resists the motion of the diaphragm, which is equal to the resistance of the suspension to diaphragm motion.

Vas may be the volume of air than, when acted upon by a piston of area Sd, has the same compliance as the driver's suspension. Vas represents the volume of air that has the same stiffness as the driver's suspension when acted on by a piston of the same area (Sd) as the cone. The piston may be the moving diaphragm.

Larger values mean lower stiffness, and generally require larger enclosures. Vas varies with the square of the effective diameter of the moving diaphragm. The effective diameter of the moving diaphragm may be the diaphragm diameter plus about 30% of the width of the surround ring. Larger values of Vas mean lower stiffness, and generally require larger speaker enclosures. Vas may be given as:

Vₐₛ=ρ·c²·S_{d}²·Cₘₛ

wherein ρ is the density of air (1.184 kg/m3 at 25° C.), c is the speed of sound (346.1 m/s at 25° C.), Sd is the area of the piston, and Cms is the Thiele-Small speaker model for speaker compliance for the speaker.

Moreover, conventional speaker enclosures might not be designed to be small. For example, when the speaker enclosure is less than Vas, there may be significant attenuation of the maximum possible speaker low frequency sound output.

Inventors of embodiments of the present disclosure have discovered metamaterials to scale down loudspeaker enclosure size and enhance performance to address one or more of the above limitations of conventional speaker enclosures.

### SUMMARY

Embodiments of the present disclosure may include a system. includes a speaker enclosure, a speaker in the speaker enclosure, and a meta cell. The meta cell includes an opening on a first end connected to the speaker enclosure, and a closed cavity on a second end.

### BRIEF DESCRIPTION OF THE DRAWINGS

FIG. 1 is an illustration of an example system with metamaterial to scale down loudspeaker enclosure size and enhance performance, according to embodiments of the present disclosure.

FIGS. 2A-2E illustrate possible implementations of a meta cell regarding a connection to an enclosure, according to embodiments of the present disclosure.

FIGS. 3A-3E illustrate example performances of various implementations of meta cells and an enclosure, according to embodiments of the present disclosure.

FIG. 4 illustrates example performance of various implementations of the system, according to embodiments of the present disclosure.

FIG. 5 illustrates operation of a given speaker in a standard enclosure and in a smaller enclosure with a meta cell, according to embodiments of the present disclosure.

FIGS. 6-7 illustrate speaker response of a configuration of the system with two instances of meta cells tuned so as to provide low frequency response of speaker according to its Fo. FIG. 6 may illustrate frequency response, while FIG. 7 may illustrate impedance.

FIG. 8 is an illustration of speaker response with three meta cells tuned to evenly spaced frequencies to provide low frequency response for a speaker in the system, according to embodiments of the present disclosure.

FIG. 9 is provided as an illustration of a standard frequency response curve for a small speaker in free space, with a Fo of 180 Hz.

FIG. 10 illustrates example THD for an embodiment of the present disclosure.

FIG. 11 illustrates additional information regarding the performance of speakers, including how THD may be incurred.

FIG. 12 also illustrates additional information regarding the performance of speakers, including how THD may be incurred.

### DETAILED DESCRIPTION

Embodiments of the present disclosure may include a system. The system may include a speaker enclosure, a speaker in the speaker enclosure, and a meta cell. The meta cell may include an opening on a first end connected to the speaker enclosure. The meta cell may include a closed cavity on a second end. The meta cell may otherwise be of any suitable shape. The speaker enclosure may be small compared to other implementations of speaker systems. The meta cells may be implemented by any suitable arrangement to create negative volume within the speaker enclosure.

In combination with any of the above embodiments, the meta cell may include an enclosed tube connecting the closed cavity and the opening.

In combination with any of the above embodiments, the meta cell may be implemented as a Helmholtz resonator.

In combination with any of the above embodiments, the meta cell may include a resonant frequency. The resonant frequency may be determined according to a size of the meta cell, including sizes of the cavity, tube, and opening. The meta cell may be tuned to its resonant frequency by adjusting the sizes of the cavity, tube, and opening. The meta cell may be tuned to a resonant frequency of a target low frequency of the system.

In combination with any of the above embodiments, the system may include another meta cell. The other meta cell may include an opening on a first end connected to the speaker enclosure, and a closed cavity on a second end. The other meta cell may include an enclosed tube connecting the closed cavity and the opening. The other meta cell may be implemented by any suitable arrangement to create negative volume within the speaker enclosure, such as a Helmholtz resonator.

In combination with any of the above embodiments, the meta cells may be tuned to a same resonant frequency.

In combination with any of the above embodiments, the meta cells may be tuned to a different resonant frequency.

In combination with any of the above embodiments, one meta cell may be tuned to a resonant frequency of a target low frequency response of the system. The other meta cell may be tuned to a higher resonant frequency compared to the first meta cell.

In combination with any of the above embodiments, the system may include yet another meta cell. The yet another meta cell may include an opening on a first end connected to the speaker enclosure, and a closed cavity on a second end. The yet another meta cell may include an enclosed tube connecting the closed cavity and the opening. The yet another meta cell may be implemented by any suitable arrangement to create negative volume within the speaker enclosure, such as a Helmholtz resonator. The yet another meta cell may be turned to a higher resonant frequency compared to the other two meta cells.

In combination with any of the above embodiments, the speaker may be configured to cause a frequency response peak at yet a higher resonant frequency that is higher than the resonant frequencies of the meta cells.

In combination with any of the above embodiments, the resonant frequency of the other meta cell may be closer to the resonant frequency of the meta cell than to the frequency response of the speaker.

In combination with any of the above embodiments, the speaker enclosure may have a volume that is less than the equivalent compliance volume of the speaker.

In combination with any of the above embodiments, the speaker enclosure may have a volume that is less than 50% of the equivalent compliance volume of the speaker.

In combination with any of the above embodiments, the speaker enclosure may have a volume that is 25% or less of the equivalent compliance volume of the speaker.

In combination with any of the above embodiments, the meta cells may be configured to provide negative space to cancel the effect of air within the speaker enclosure.

In combination with any of the above embodiments, the meta calls may be configured to cause a low frequency response for the system at the resonant frequency of the meta cells and at a frequency above the resonant frequency of the meta cells based on the resonant frequency of the speaker.

In combination with any of the above embodiments, the meta cells may be configured to stabilize a total frequency response of the system by reducing an effect of variation of a resonant frequency of the speaker.

In combination with any of the above embodiments, the meta cells may be connected to respective external surfaces and openings of the speaker enclosure.

In combination with any of the above embodiments, the tubes of the meta cells may be partially implemented within and open into the speaker enclosure, and the respective cavities may be implemented outside the speaker enclosure.

In combination with any of the above embodiments, the tubes of the meta cells may be implemented within and open into the speaker enclosure, and the respective cavities may be implemented outside the speaker enclosure.

In combination with any of the above embodiments, the tubes of the meta cells may be implemented within and open into the speaker enclosure, and the respective cavities may be implemented within the speaker enclosure.

In combination with any of the above embodiments, the meta cells may be implemented outside the speaker enclosure and connected to the speaker enclosure through acoustic coupling. Acoustic coupling may include coupling the speaker and enclosure within less than ¼ of a wavelength of each other.

In combination with any of the above embodiments, the meta cells may be implemented by, for example, a maze array, with narrow winding channels of subwavelength dimensions tuned to the desired wavelength that react or respond to the sound energy; by membrane arrays, wherein cells are covered with thin film under tension with a mass attached to create a resonant structure that reacts or responds to the sound energy at a given frequency; or, for example, by sonic crystals, wherein an array of mechanical resonating rods or other elements are tuned to react or respond to sound energy.

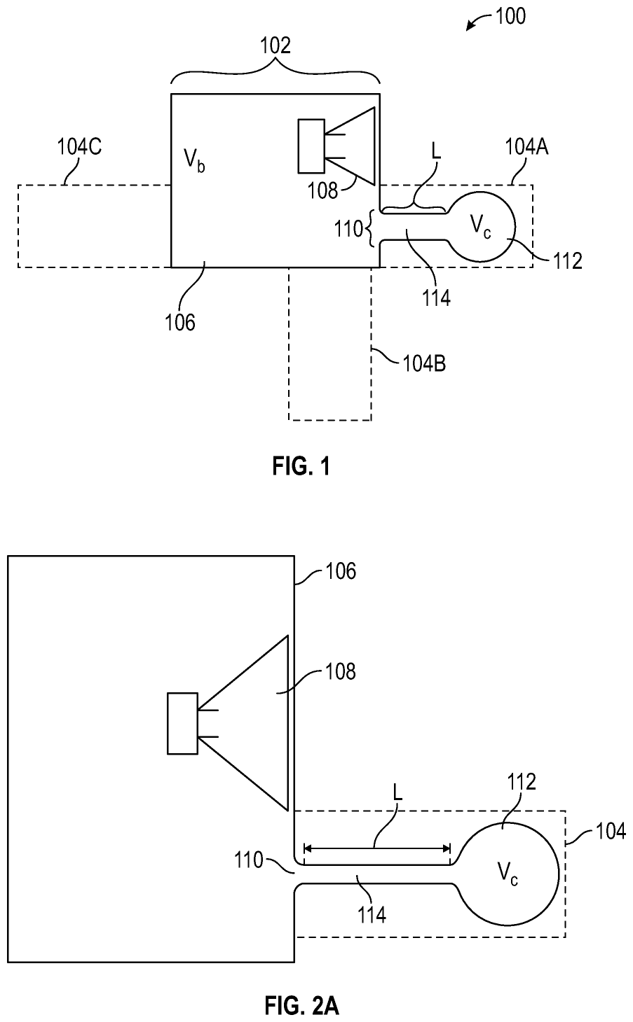

FIG. 1 is an illustration of an example system 100 with metamaterial to scale down loudspeaker enclosure size and enhance performance, according to embodiments of the present disclosure.

System 100 may include a speaker subsystem 102 and one or more meta cells 104. Other portions of system 100, such as electronics to power speaker subsystem 102 and provide signals to be emitted from speaker subsystem 102, may be included in system 100 but are not shown in FIG. 1. Any suitable number and kind of meta cells 104 may be used. Moreover, meta cells 104 may be implemented in a same or a different manner compared to one another.

Speaker subsystem 102 may be implemented in any suitable manner. Speaker subsystem 102 may be configured to emit audio signals of various frequencies. Speaker subsystem 102 may include a speaker 108 enclosed within an enclosure 106. Speaker 108 may be implemented in any suitable manner. One or more speakers may be within an enclosure 106. Enclosure 106 may be of a volume given as Vb.

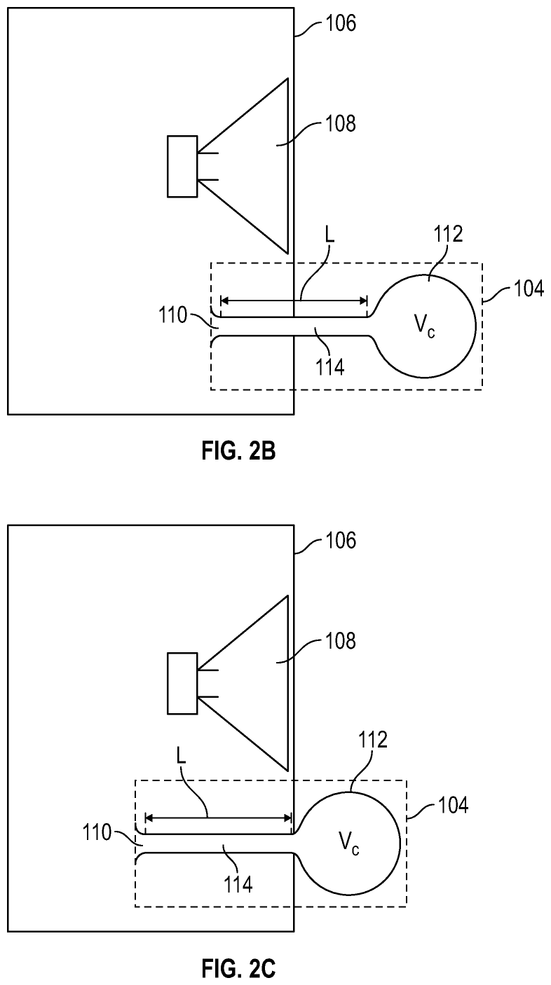

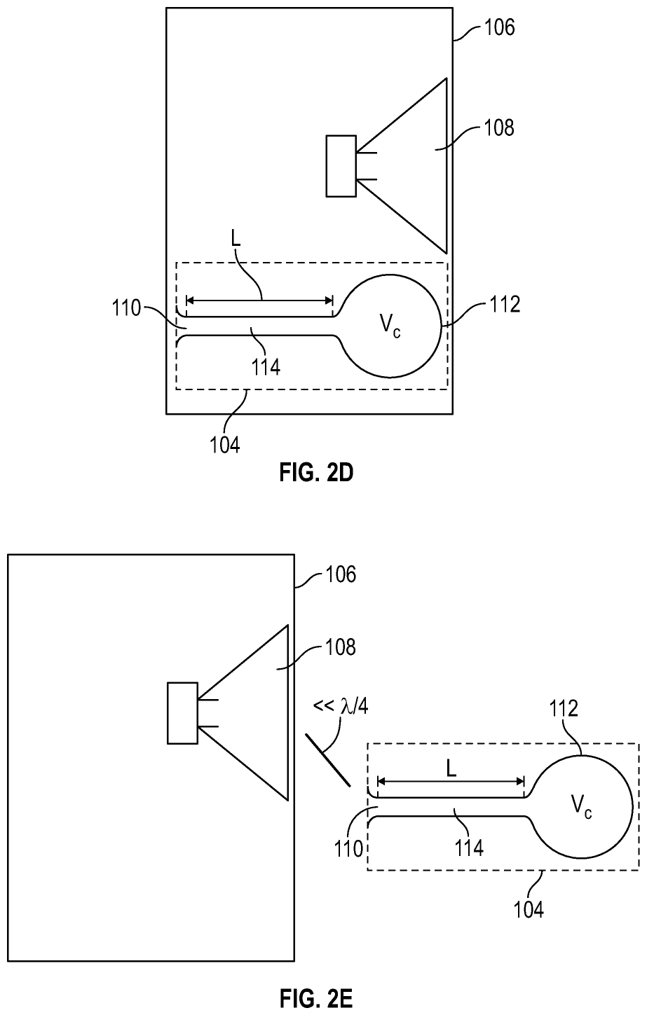

In one embodiment, system 102 may include a tube 114. Although shown as part of meta cell 104 in FIG. 1, tube 114 may be included within speaker subsystem 102 or within meta cell 104, as shown in various possible implementations in more detail in FIG. 2, discussed in more detail below.

Meta cell 104 may include tube 114 of a length L. Moreover, tube 114 may have an opening 110 of an area A connecting enclosure 106 and meta cell 104. Meta cell 104 may include a cavity 112 of a volume Vc. Cavity 112 may be of any suitable shape, dimensions, or volume, whether regular or irregularly shaped.

Meta cell 104 may be connected to enclosure 106 in any suitable manner. Although shown as attached to an external surface of enclosure 106 through an opening defined by opening 110, several possible implementations of connecting meta cell 104 to enclosure 106 may be used.

FIGS. 2A-2E illustrate possible implementations of meta cell 104 regarding a connection to enclosure 106, according to embodiments of the present disclosure. FIGS. 2A to 2D illustrate various topological configuration options for various application and product manufacturing needs. FIG. 2E illustrates possible acoustic lens applications affecting sound dispersion.

In FIG. 2A, meta cell 104 may be implemented entirely outside of enclosure 106, but may be connected via opening 110.

In FIG. 2B, meta cell 104 may be implemented partially inside and partially outside of enclosure 106. Opening 110 from tube 114 may open into enclosure 106. Tube 114 may be partially within enclosure 106.

In FIG. 2C, meta cell 104 may be implemented partially inside and partially outside of enclosure 106. Opening 110 from tube 114 may open into enclosure 106. Tube 114 may be entirely within enclosure 106. Cavity 112 may be entirely outside enclosure 106.

In FIG. 2D, meta cell 104 may be implemented entirely within enclosure 106. Opening 110 from tube 114 may open into enclosure 106. Tube 114 and cavity 112 may be entirely within enclosure 106.

In FIG. 2E, meta cell 104 may be implemented entirely outside of enclosure 106, and might not be physically connected to enclosure 106. Opening 110 may open to output of speaker 108. The system of FIG. 2E may have reduced performance unless meta cell 104 is tightly acoustically coupled within speaker 108 with deep subwavelength separation, such as less than ¼ of a wavelength.

Returning to FIG. 1, the possible implementations of meta cell 104 with respect to enclosure 106 and speaker 108 in system 100 may be in contrast to implementations of bass ports, wherein a tube in an enclosure would open to free space outside of the enclosure through an exit vent. The use of a bass port may apply speaker sound pressure to the exit vent. Moreover, with a bass port, two sources of sound energy may exist—the speaker and the exit vent. In contrast, embodiments of the present disclosure may output to a cavity of air within the enclosure and not to any exit vent, and sound may be emitted solely from speaker 106.

Meta cell 104 may be implemented by, for example, a Helmholtz array or Helmholtz resonator. Meta cell 104 may be configured to resonate at a given frequency and react to sound energy provided by speaker 108. Meta cell 104 may be implemented by, for example, a maze array, with narrow winding channels of subwavelength dimensions tuned to the desired wavelength that react or respond to the sound energy. Meta cell 104 may be implemented by, for example, membrane arrays, wherein cells are covered with thin film under tension with a mass attached to create a resonant structure that reacts or responds to the sound energy at a given frequency. Meta cell 104 may be implemented by, for example, sonic crystals, wherein an array of mechanical resonating rods or other elements are tuned to react or respond to sound energy.

Enclosure 106 may be used to prevent a loss of low frequency response and to prevent distortion. This loss of low frequency response and distortion may occur if speaker 108 was otherwise openly used without an enclosure. In many applications such as conference phones, acoustic and mechanical design factors for speaker performance may suggest that a frontside of speaker 108 be open to free space as much as possible. The backside of speaker 108 may be hermetically sealed (such as by enclosure 106) to facilitate the preservation of low frequency response and to prevent total distortion.

Enclosure 106 may be rigid to prevent sound distortion from parasitic surface vibrations. An air seal gasket of speaker 108 may be a thin solid adhesive to prevent frame motion and give a good low-frequency air seal. The shape of enclosure 106 may be configured to prevent standing waves in the audio frequency range of system 100. Speaker 108 should not be placed at the ¼^{th} wavelength node of a standing wave generated by enclosure 106, so as to minimize driving force efficiency. Enclosure 106 may be configured to be mechanically stable to prevent coupled resonance of the mechanical supports or chassis.

Speaker 108 may have a resonant frequency that may be observed when speaker 108 is in free space, as opposed to in enclosure 106. The resonant frequency may be given as Fo. The following descriptions of behavior regarding resonant frequency may be observed when speaker 108 is implemented in free space. As the output of speaker 108 ranges from higher frequencies down to a lower, resonant frequency of speaker 108, performance may peak, and then rapidly fall off as frequencies go below the lower, resonant frequency. If speaker 108 was, for example, small with a diameter of 50 mm, the resonant frequency may be about 180 Hz. As the frequency of speaker 108 output decreases and reaches Fo from higher frequencies, the sound output may increase. At Fo, speaker 108 output peaks. Below Fo, speaker 108 output drops at about 20 dB per decade of frequency. If, instead, speaker 108 is placed in a sealed enclosure, such as enclosure 106, lower frequencies are prevented from being cancelled because of opposite phases from the front and back of the diaphragm. The resonate frequency of this arrangement, implemented without meta cells 104 and referenced as, for example, Fb, may instead increase to approximately 300 Hz or more due to the stiffness of the enclosed air volume of enclosure 106. For many applications, the volume of enclosure 106 may be, for example, about 200 cc for desktop devices.

The resonant frequency of speaker 108 by itself, Fo, is related to, but not equal to, the lowest operating frequency of speaker subsystem 102 if a bass port or meta cell 104 is used. The low frequency response of a given system 100 may be enhanced with use of meta cell 104, as discussed in further detail below. A given meta cell 104 may be designed with a particular frequency. The frequency selected may so-selected as to approximate the resonant frequency of speaker subsystem 102 if a bass port were used. The frequency of a given meta cell may be expressed as Fmc.

As discussed above, in many applications, the volume Vb of enclosure 106 may be two times or greater than the Vas of speaker 108. However, in one embodiment, use of meta cell 104 may facilitate the reduction of the size of enclosure 106. Inventors of embodiments of the present disclosure have discovered that use of one or more meta cells 104 have allowed the size of enclosure 106 to be reduced to less than 25% of currently used sizes of speaker enclosures without reduction in acoustic performance. This reduction in speaker enclosure size may allow more flexibility with the acoustic product industrial design and may reduce material cost.

In another embodiment, through use of one or more instances of meta cell 104, the effective low frequency output of system 100 may be reduced below Fo. This may effectively create “negative” space. As analogous to the model shown in FIG. 2, for a given enclosure 106, the contained air therein (of volume Vb) acts as spring restricting the motion of the diaphragm of speaker 108, which is natural positive air space. However, the volume of air Vc within meta cell 104 cancels the effect of the air spring, acting as a negative space or negative compliance. Meta cell 104 may cancel both the air volume compliance and the effective suspension compliance of speaker subsystem 102. This is shown when the use of meta cell 104 has a resonant frequency that pushes system 100 to operating at a frequency below Fo.

The low frequency response of system 100 may be improved at a frequency of each meta cell 104. The frequency of a given meta cell 104, Fmc, may be given as:

$${f}_{mc} = \frac{v}{2 π} \sqrt{\frac{A}{{V}_{c} \times L}}$$

wherein v is the velocity of sound at a given temperature and humidity, A is the area of opening 110 for tube 114 of length L, Vc is the volume of cavity 112, Leq is the equivalent length of tube 114. This may also be given as:

$${f}_{mc} = \sqrt{\frac{2.37 \times {10}^{7} \times {D}^{2}}{{V}_{c} \times ( L + K \times D )}}$$

wherein D is the diameter of tube 114, and constant (2.37×10⁷) and K are correction factors empirically derived, and the dimensions are given in CGS units.

A given instance of meta cell 104 may be built according to a desired resonant frequency Fmc. In order to achieve the desired resonant frequency, the area of opening 110 for tube 114, Vc is the volume of cavity 112, Leq is the equivalent length of tube 114, or the diameter of tube 114 may be varied.

As shown in FIG. 1, meta cells 104 may be attached to enclosure 106 on the outside of enclosure 106. A coupled resonator system may be formed as a result. Cell-to-cell or cell-to-speaker resonator coupling may include near field energy or pressure wave couple, or evanescent wave coupling that occurs with deep subwavelength cell-to-cell spacing. Cell-to-speaker coupling may yield coupled resonators if the spacing is subwavelength. Subwavelength of a given meta cell 104 may be evaluated by dividing the largest dimension of the meta cell 104 by the wavelength of the resonant frequency (Fmc) of the meta cell 104. The results of this evaluation may yield relative determinations of subwavelength nature of the meta cell 104. For example, a ratio of 1/10 may be considered subwavelength. A ratio of 1/100 may be considered to be deep subwavelength. Meta cells 104 may be, for example, a 1/20 subwavelength.

The pressure coupling between meta cells 104 or meta cell 104 and enclosure 106 may depend upon the structure of enclosure 106. The evanescence energy coupling may be accomplished by evanescence waves that decay exponentially with distance. Evanescent waves may be produced when an incident wave strikes an interface at an angle exceeding a critical angle. The wave may then decay exponentially within the refractive medium. A coupling may be considered close as defined by the exponential decay within a wavelength distance related to wavelength of the sound, such that the coupled elements might still affect the sound waves in question. The coupling may be considered to be near unity for 1/100^{th} of a wavelength spacing and greatly reduced when spaced by ¼^{th} of a wavelength.

In one embodiment, the size of enclosure 106 may be reduced to increase meta cell to meta cell and meta cell to speaker coupling. Moreover, meta cells 104 may increase low frequency response of system 100 when meta cells 104 are tuned to a frequency lower than speaker resonance (Fo) of speaker 108. This increase in low frequency response may offset effects of reducing the size of enclosure 106. Implementations of meta cell 104 according to Helmholtz configurations, as shown in FIG. 1, have been discovered to have a larger effect with smaller speaker enclosure volumes.

Moreover, from experiments conducted wherein system 100 has three instances of meta cells 104, close spacing of the meta cells 104 may form resonators that improve the total overall effect of low frequency response. Experiments have shown that adding multiple identical or disparate meta cells 104 may improve performance. This may contrast other solutions wherein multiple identical conventional bass ports may have the opposite effect, and the resonant frequency of the system increases. Furthermore, the net speaker enclosure volume of enclosure 106 can be reduced to less than 10% of Vas with subwavelength meta cells 104. As discussed above, the resonant frequency of a given meta cell 104 (Fmc) may be lower than the free space resonance of speaker 108 (Fo), effectively creating negative space or compliance. The Q of a single meta cell 104 can be decreased with acoustic fiber or mesh, spreading the effect over a wider frequency range. The Q may be a quality factor, given as the width of the −3 db response frequencies above and below the resonant frequency peak. However, in system 100, a low Q may be desirable to improve low frequency performance, as the low frequency boost benefits provided by meta cells 104 may be spread over a wide frequency span to yield a smoother bass boost response.

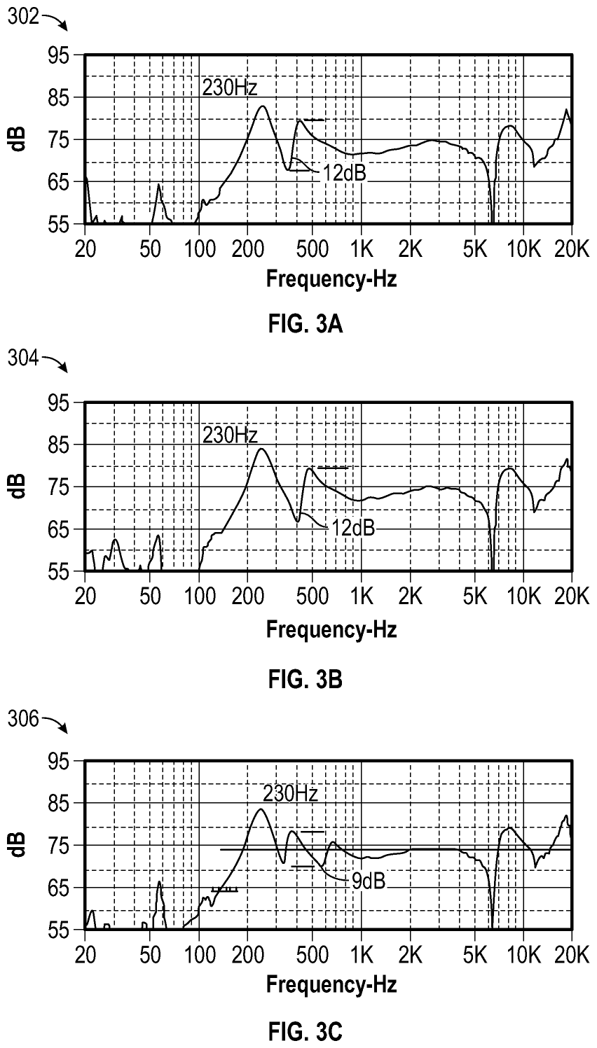

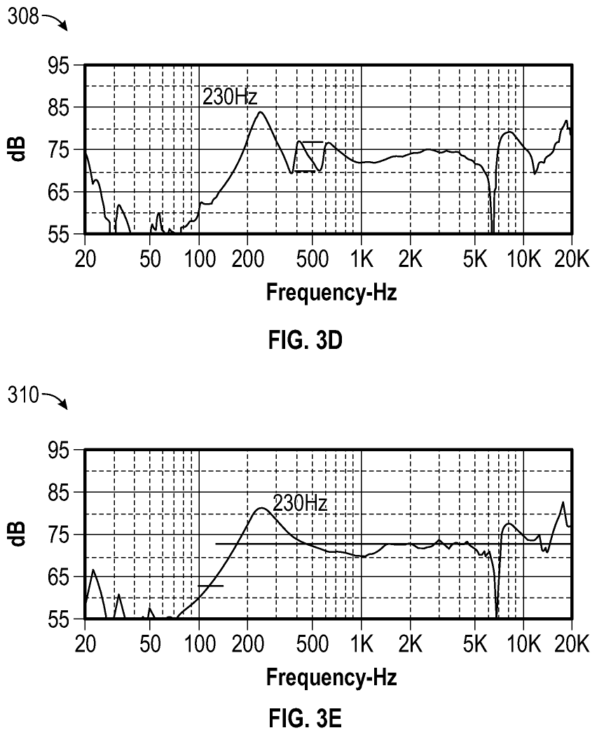

FIGS. 3A-3E illustrate example performances of various implementations of meta cells 104 and enclosure 106, according to embodiments of the present disclosure. In each of graphs 302-310, a low frequency response of 230 Hz for system 100 was targeted. Graphs 302 illustrate low frequency response peaks corresponding to the resonant frequency of the single meta cell and the speaker.

In graph 310, performance of a baseline enclosure without any meta cells is illustrated. The enclosure may be 250 cc in volume. The target frequency for the resultant subsystem including the speaker and enclosure may be 230 Hz.

Graph 302 illustrates low frequency response peaks corresponding to the resonant frequency of the single meta cell and the speaker. In graph 302, instead of a 250 cc enclosure, a combined minimum size speaker enclosure and meta cell may be used. The minimum size speaker enclosure itself may be much smaller, measuring 10 cc. The meta cell may include a 30 cc cavity and a 4 cc tube. Thus, the combined effective volume of the meta cell and the minimum size speaker enclosure may be 44 cc, which is merely 18% as large as the enclosure of graph 310. The response provided by the minimum size speaker enclosure of 10 cc may be supplanted by the response provided by the meta cell, which was designed with an Fmc corresponding to 230 Hz. This response may still be centered at 230 Hz, but may be greater in magnitude or comparable to the 250 cc enclosure response at 230 Hz, when comparing graphs 302 and 310. Moreover, additional response may be provided at a slightly higher frequency, such as at approximately 425 Hz. This additional response may be due to the speaker. The peak to valley difference in this additional response may be 12 dB. This may thus be the variation in frequency response.

Graph 304 illustrates low frequency response peaks corresponding to the resonant frequency of the single meta cell and the speaker. In graph 304, instead of a 250 cc enclosure, a combined minimum size speaker enclosure and meta cell may be sued. The minimum size speaker enclosure itself may be much smaller, measuring 10 cc. The cavity of the meta cell may measure 35 cc and the tube of the meta cell may measure 9 cc. Thus, the combined effective volume of the meta cell and the minimum size speaker enclosure may be 54 cc, which is 22% as large as the enclosure of graph 310. The response provided by the minimum size speaker enclosure of 10 cc may be supplanted by the response provided by the meta cell, which was designed with an Fmc corresponding to 230 Hz. This response may still be centered at 230 Hz, but may be greater in magnitude or comparable to the 250 cc enclosure response at 230 Hz, when comparing graphs 304 and 310. Moreover, additional response may be provided at a slightly higher frequency. This additional response may be due to the speaker. The peak to valley difference in this additional response may be 12 dB. This may thus be the variation in frequency response for this implementation of system 100.

Graph 306 illustrates the frequency response of two meta cells and the speaker. In graph 306, instead of a 250 cc enclosure, a combined minimum size speaker enclosure and two meta cells may be used. The minimum size speaker enclosure itself may be much smaller, measuring 10 cc. Moreover, a meta cell with a cavity with a volume of 10 cc, a meta cell with a cavity with a volume of 30 cc may be used. Tubes for the two meta cells may be 12 cc in total. The combined effective volume of the meta cells and the minimum size speaker enclosure may be 62 cc, which is 25% as large as the enclosure of graph 310. The response provided by the 10 cc minimum size speaker enclosure may be supplanted by the response provided by the first meta cell, which was designed with an Fmc1 corresponding to 230 Hz. The response may still be centered at 230 Hz, but may be greater in magnitude or comparable to the 250 cc enclosure response at 230 Hz, when comparing graphs 304 and 310. Moreover, additional responses may be provided at slightly higher frequencies according to the resonant frequencies of the other meta cell and the speaker, given as Fmc2 and Fo. Fmc2 may be approximately 375 Hz. The additional response due to the speaker might not be precisely at Fo. The peak to valley difference in this additional response may be 9 dB. This may thus be the variation in frequency response for this implementation of system 100. The two meta cells shown in graph 306 may cause a smoother frequency response compared to graphs 302, 304, and the peak to valley difference in the additional responses is only 9 dB, compared to 12 dB. This may be achieved through use of the additional meta cell. Other solutions might require software equalization to achieve such results.

In graph 308, instead of a 250 cc enclosure, a combined minimum size speaker enclosure and two meta cells may against be used. The minimum size speaker enclosure itself may be much smaller, measuring 10 cc. Moreover, a meta cell with a cavity with a volume of 10 cc and a meta cell with a cavity with a volume of 35 cc may be used. Tubes for the two meta cells may be 12 cc in total. The combined effective volume of the meta cells and the minimum size speaker enclosure may be 67 cc, which is 27% as large as the enclosure of graph 310. The response provided by the 10 cc minimum size speaker enclosure may be supplanted by the response provided by the first meta cell, which was designed with an Fmc1 corresponding to 230 Hz. The response may still be centered at 230 Hz, but may be greater in magnitude or comparable to the 250 cc enclosure response at 230 Hz, when comparing graphs 304 and 310. Moreover, additional responses may be provided at slightly higher frequencies according to the resonant frequencies of the other meta cell and the speaker, given as Fmc2 and related to Fo. The peak to valley difference in this additional response may be 9 dB. This may thus be the variation in frequency response for this implementation of system 100. The two meta cells shown in graph 308 may cause a smoother frequency response compared to graphs 302, 304, and the peak to valley difference in the additional responses is only 9 dB, compared to 12 dB. This may be achieved through use of the additional meta cell. Other solutions might require software equalization to achieve such results.

The lowest variation in response may be shown in graph 306, and thus the selection of the particular meta cells therein may be used, as well as the defined size of the enclosure. The lower variation in response may be achieved by, for example, targeting Fmc2 to be closer to Fmc1 than to the peak corresponding to the speaker.

In the examples of FIG. 3, wherein multiple meta cells are used, a larger volume meta cell may be used to target the base frequency of 230 Hz, and a smaller volume meta cell may be used to target the higher frequency. This other meta cell may be designed with a target frequency that is halfway between the lower frequency meta cell and the speaker resonant peak. Further adjustment of the frequencies of the meta cells may be made by shortening or lengthening the tube.

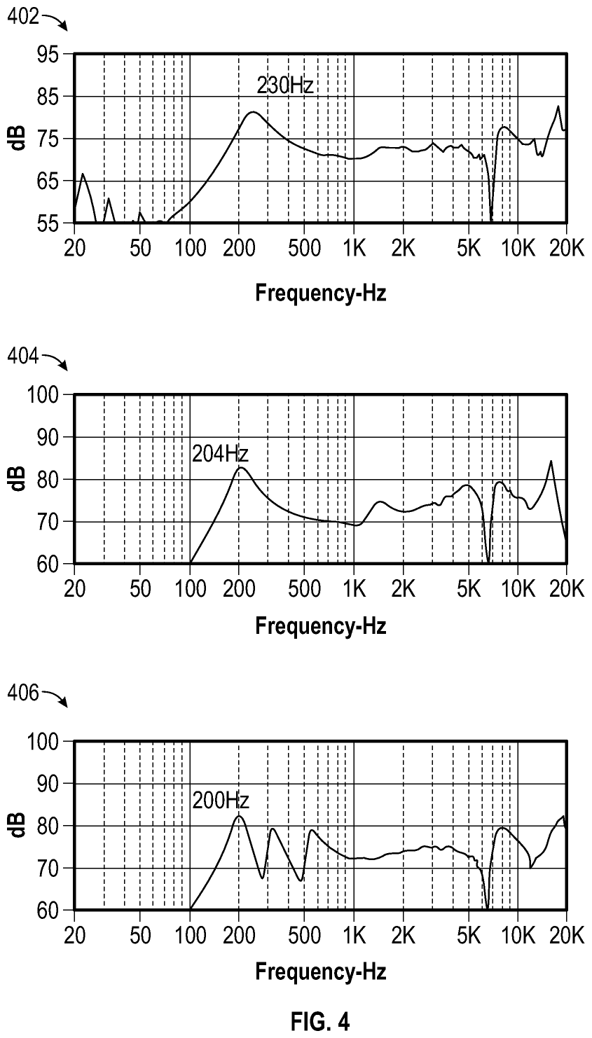

FIG. 4 illustrates example performance of various implementations of system 100, according to embodiments of the present disclosure. In particular, FIG. 4 illustrates how a given speaker performance may vary when placed in free space, in an enclosure without a meta cell, and in an enclosure with a meta cell.

In graph 402, speaker 108 may be in an enclosure 106 that is large, such as 250 cc. Speaker subsystem 100 may have a resonant frequency, Fb, of 230 Hz. A meta cell 104 might not be used.

In graph 404, speaker 108 may be in free space, and may have a resonant frequency, Fo, of 204 Hz.

In graph 406, speaker 108 may be in an enclosure 106 that is small, such as 10 cc, as well as meta cells 104 that are 90 cc and 18 cc, respectively, for an effective volume of 130 cc. System 100 have an effective resonant frequency of 200 Hz, which may correspond to a Fmc1 of meta cell 104 that is 90 cc large. Meta cells 104 can push the effective resonant frequency and response below the Fo of speaker 108. Moreover, this may be achieved with an instance of enclosure 106 that is effectively 52% of the original volume of enclosure 106. Thus, use of meta cell 104 may allow dramatically smaller enclosures 106, as well as better low frequency response.

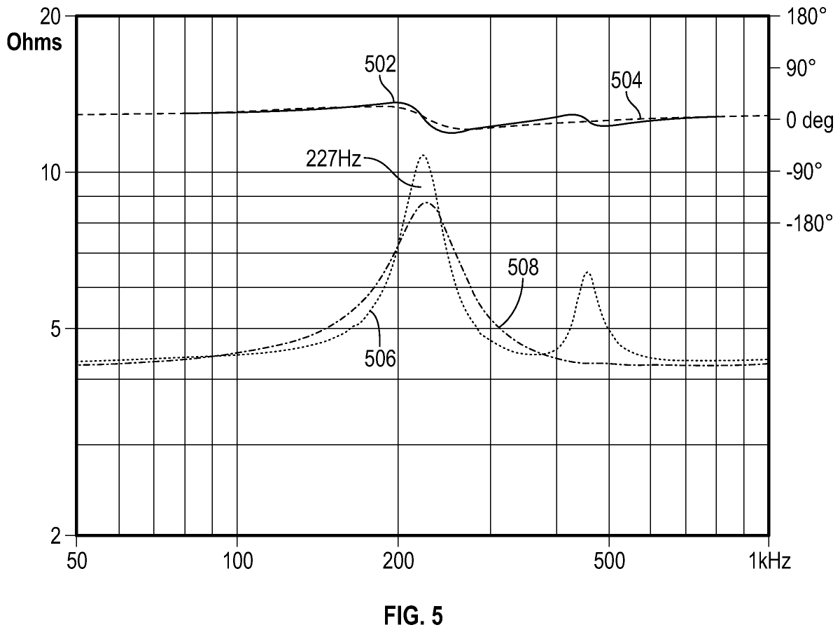

FIG. 5 illustrates operation of a given speaker in a standard enclosure and in a smaller enclosure with a meta cell, according to embodiments of the present disclosure.

Plots 502, 508 illustrate operation of speaker 108 in an enclosure, such as a conference phone enclosure, that is relatively large. This may be a first configuration. In contrast, plots 504, 506 illustrate operation of speaker 108 in a smaller enclosure 106, such as a 30 cc enclosure, with a meta cell 104 of size 50 cc. This may be a second configuration.

Plots 502, 504 illustrate that the output phase of speaker 108 has an output phase with respect to frequency that is equivalent between the two configurations.

To design the second configuration and reduce the size of enclosure 106, volume of meta cell 104 may be adjusted to match the peak impedance of speaker 108 as it resides in the larger enclosure. Thus, the conventional speaker enclosure of 250 cc was reduced to about 60 cc in enclosure 106 with equivalent low frequency performance with a single meta cell 104. This is illustrated by plots 506, 508. The frequency response of the second configuration illustrated in plot 506 meets or exceeds the frequency response in plot 508 of the first configuration, matched to the target resonant frequency of 227 Hz. Matching of the target resonant frequency may be performed in any suitable manner, such as beginning with a certain net volume of a given meta cell 104, and adjusting tube length or diameter to match the frequency that is desired. Conversely, a given tube may be selected with a specified length or diameter, and adjusting a volume of the cavity of the meta cell 104 to achieve the given resonant frequency.

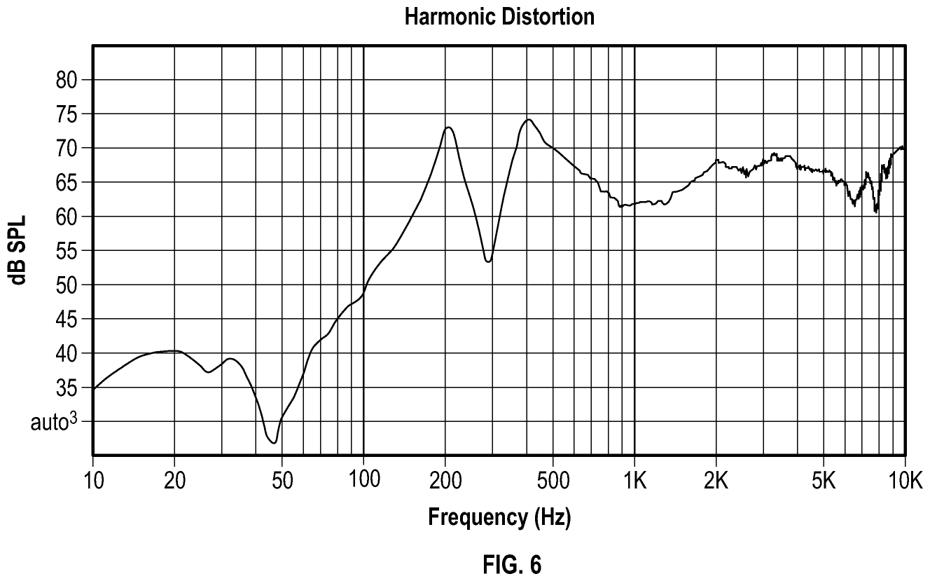

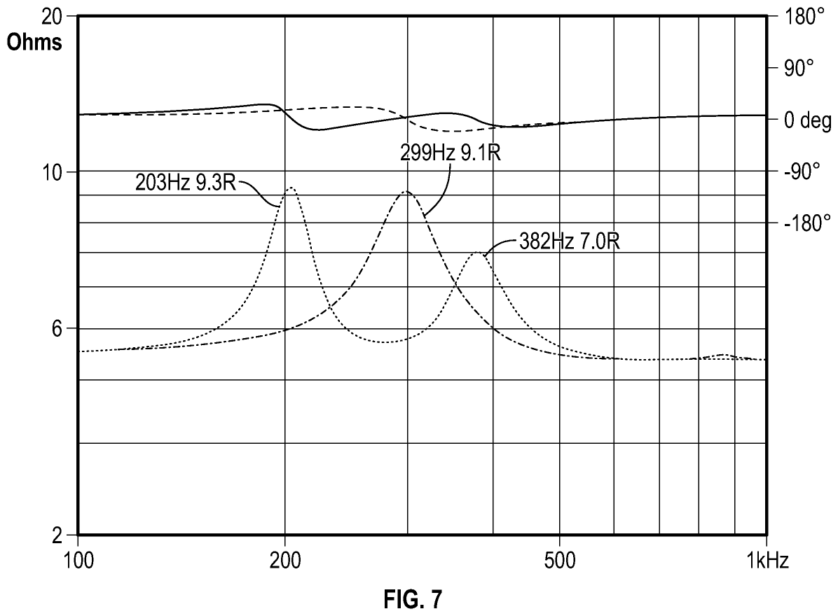

FIGS. 6-7 illustrate speaker response of a configuration of system 100 with two instances of meta cells 104 tuned so as to provide low frequency response of speaker 106 according to its Fo. The two instances of meta cells 104 may be tuned to the same frequency, Fmc, and thus increase the low frequency response for system 100. FIG. 6 may illustrate frequency response, while FIG. 7 may illustrate impedance. The frequency response and impedance graphs show that identical meta cells 104 work together to increase the low frequency response of system 100, in contrast to use of, for example, two bass ports which reduces the boost amplitude. If two bass ports were used, the effective frequency peak would be at a higher frequency of a factor of about the square root of two. The trace labeled with a 299 Hz peak may be the impedance versus the frequency of a speaker alone in a 250 cc enclosure. The trace labeled with peaks at 203 Hz and 382 Hz may be the effective impedance versus the frequency of a speaker in a smaller enclosure with a meta cell.

Returning to FIG. 1, it is noted that three instances of meta cells 104 may be used. Inventors of embodiments of the present disclosure have discovered that, from experiments wherein enclosure 106 is utilized three instances of meta cells, several unexpected results occur. The coupled meta cells 104 stabilize the total frequency response by reducing the effect of variation of the Fo of speaker 108 by up to 50%. Variations of the Fo of speaker 108 may arise from, for example, variations in speaker manufacturing materials and assembly tolerances, which are wider than manufacturing variations of the mechanical dimensions of meta cell 104. The total harmonic distortion may be reduced with meta cells 104 in a similar manner as with a bass port or passive radiator by reducing speaker diaphragm travel, depending on how many instances of meta cells 104 are used.

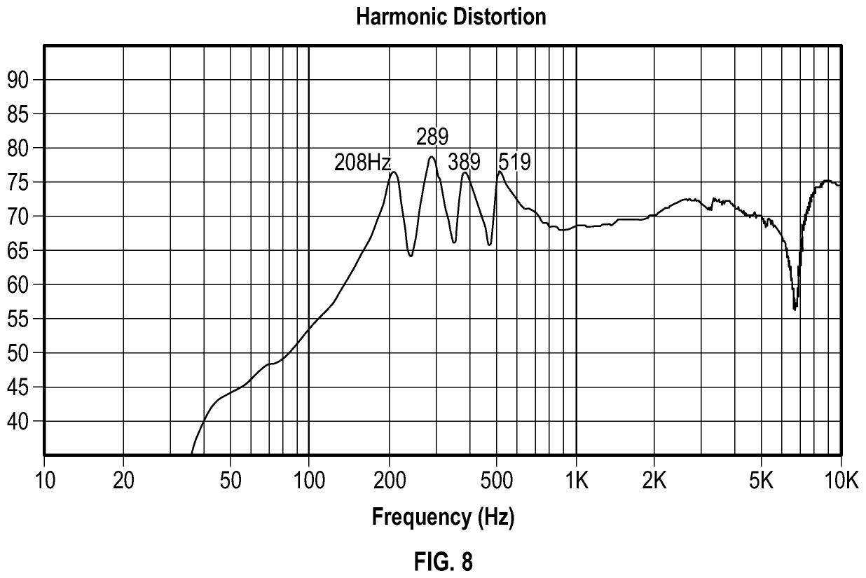

FIG. 8 is an illustration of speaker response with three meta cells 104 tuned to evenly spaced frequencies to provide low frequency response for speaker 108 in system 100, according to embodiments of the present disclosure. Meta cells 104 may have Fmc values of 208 Hz, 289 Hz, and 389 Hz, wherein a resonant frequency peak for speaker 108 may occur at 519 Hz. Setting the multiple meta cells 104 these values extends the lower frequency response. This lowers the Q of each resonance, smoothing the total response. Each higher frequency meta cell 104 is proportionally smaller in size. The peak to dip response is 20 dB in FIG. 6 for one instance of meta cell 104. In FIG. 8, the peak to response is 10 dB for three instances of meta cells 104.

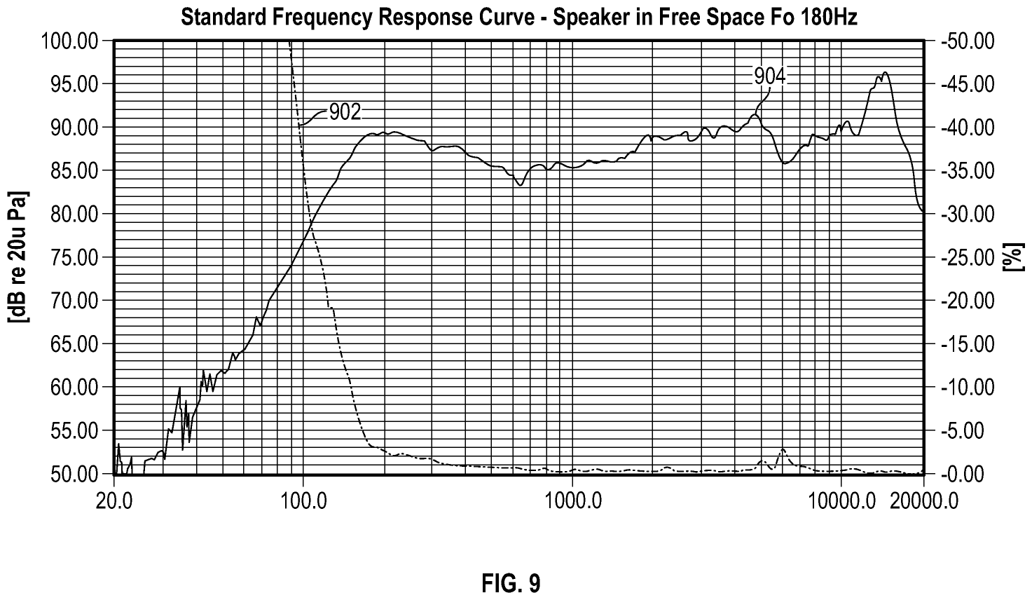

For reference, FIG. 9 is provided as an illustration of a standard frequency response curve for a small speaker in free space, with a Fo of 180 Hz. Plot 902 may represent total harmonic distortion (THD). Plot 904 may represent response of the speaker. As shown, as the frequency decreases and reaches the resonant frequency of the speaker, Fo of 180 Hz, response shown in plot 904 may begin to drop and THD shown in plot 902 may start to increase. This may be due to, for example, increased diaphragm displacement of the speaker and reduced low frequency efficiency.

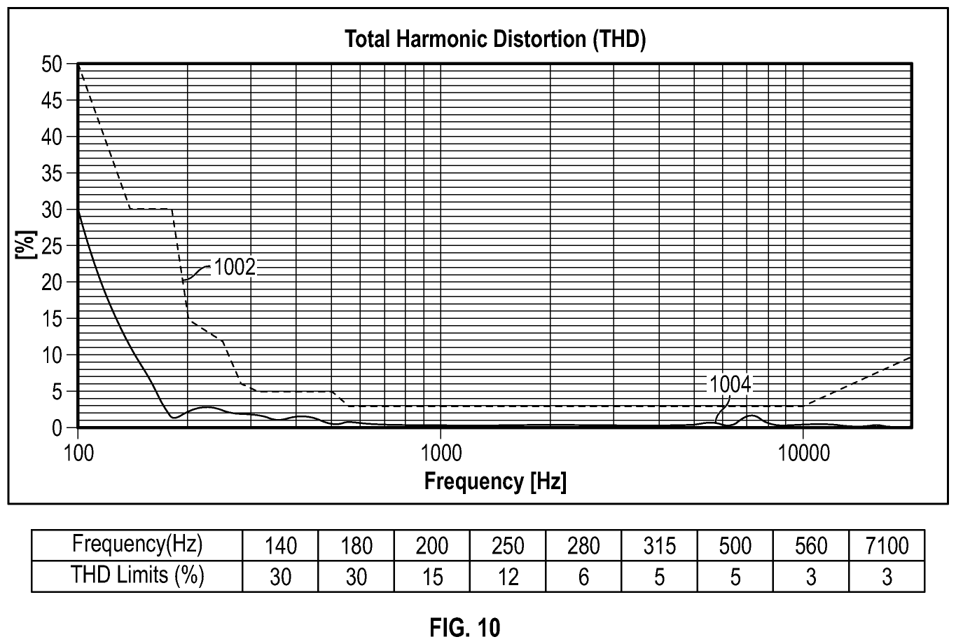

In contrast, FIG. 10 illustrates example THD for an embodiment of the present disclosure. Plot 1002 illustrates an example design standard or THD limit for example speaker applications, which may approximate the performance of many systems. The THD limit may vary non-linearly according to frequency. Plot 1004 illustrates THD performance of example embodiments, which are less than the THD limit shown in plot 1002. In particular, plot 1004 illustrates substantial increased performance in terms of THD for lower frequencies such as less than 300 Hz.

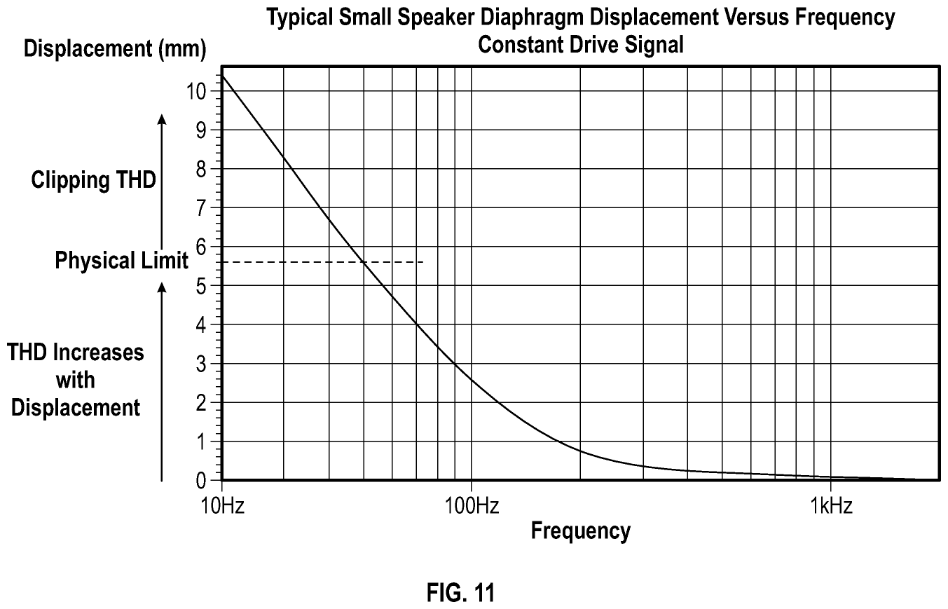

FIG. 11 illustrates additional information regarding the performance of speakers, including how THD may be incurred. In particular, FIG. 11 illustrates of plot of displacement of a speaker diaphragm. The speaker may be a typical small speaker. The displacement is plotted against possible frequencies. As frequency decreases, displacement of the speaker diaphragm may increase. This may cause a rise in THD. At some point, the physical limit of the speaker diaphragm may be reached. The speaker diaphragm can be displaced no further. At this point, clipping THD may occur.

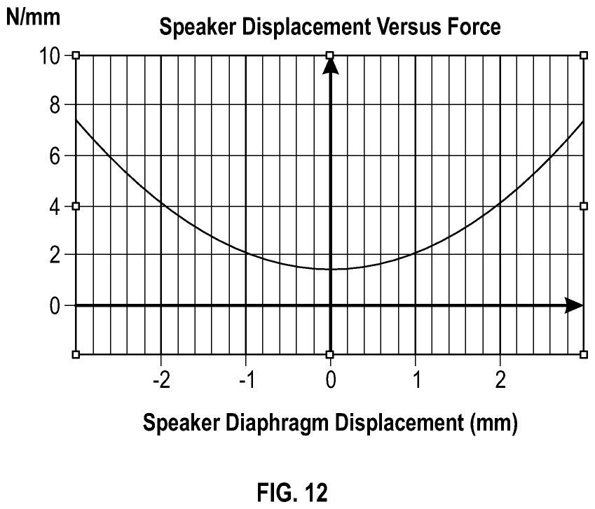

FIG. 12 also illustrates additional information regarding the performance of speakers, including how THD may be incurred. In particular, FIG. 12 illustrates a plot of diaphragm displacement and the force necessary to cause such displacement. The suspension of the speaker may act as a spring, wherein larger displacements require exponentially greater force. This non-linear response may increase THD as the displacement, whether negative or positive, is increased.

Returning to FIG. 1, absorption filters may be added to portions of meta cells 104. For example, acoustic mesh or fiber can be added to portions of meta cells 104 to lower the meta cell response Q. The Q could be reduced with a simple curved tube or an s-curved tube for meta cells 104 that spreads the frequency response.

Although example embodiments have been described above, other variations and embodiments may be made from this disclosure without departing from the spirit and scope of these embodiments.

We claim:

1. A system, comprising:
a speaker enclosure;
a speaker in the speaker enclosure; and
a first meta cell, including:
an opening on a first end connected to the speaker enclosure; and
a closed cavity on a second end.

2. The system of claim 1, further comprising a second meta cell, the second meta cell including:
an opening on a first end connected to the speaker enclosure; and
a closed cavity on a second end.

3. The system of claim 2, wherein the first meta cell and the second meta cell are tuned to a same resonant frequency.

4. The system of claim 2, wherein the first meta cell and the second meta cell are tuned to different resonant frequencies.

5. The system of claim 4, wherein:
the first meta cell is tuned to a resonant frequency of a target low frequency of the system; and
the second meta cell is tuned to a higher resonant frequency compared to the first meta cell.

6. The system of claim 4, wherein:
the first meta cell is tuned to a first resonant frequency;
the second meta cell is tuned to a second resonant frequency, the second resonant frequency higher than the first resonant frequency; and
the speaker is configured to cause a frequency response peak at a third resonant frequency, the third resonant frequency higher than the second resonant frequency.

7. The system of claim 6, wherein the second resonant frequency is closer to the first resonant frequency than the second resonant frequency is to the third resonant frequency.

8. The system of claim 2, further comprising a third meta cell, the third meta cell including:
an opening on a first end connected to the speaker enclosure; and
a closed cavity on a second end.

9. The system of claim 1, wherein the speaker enclosure has a volume that is less than the equivalent compliance volume of the speaker.

10. The system of claim 9, wherein the speaker enclosure has a volume that is less than 50% of the equivalent compliance volume of the speaker.

11. The system of claim 10, wherein the speaker enclosure has a volume that is 25% or less of the equivalent compliance volume of the speaker.

12. The system of claim 1, wherein the meta cell is configured to provide negative space to cancel the effect of air within the speaker enclosure.

13. The system of claim 1, wherein the meta cell is configured to cause a low frequency response for the system at the resonant frequency of the meta cell and at a frequency above the resonant frequency of the meta cell based on the resonant frequency of the speaker.

14. The system of claim 1, wherein the meta cell is implemented with a Helmholtz resonator.

15. The system of claim 1, wherein the meta cell is configured to stabilize a total frequency response of the system by reducing an effect of variation of a resonant frequency of the speaker.

16. The system of claim 1 wherein the first meta cell is tuned to a resonant frequency of a target low frequency of the system.

17. The system of claim 1, wherein the opening of the first meta cell is connected to an external surface and opening of the speaker enclosure.

18. The system of claim 1, wherein:
the first meta cell includes a tube and a cavity;
the tube is partially implemented within and opens into the speaker enclosure; and
the cavity is implemented outside the speaker enclosure.

19. The system of claim 1, wherein:
the first meta cell includes a tube and a cavity;
the tube is implemented within and opens into the speaker enclosure; and
the cavity is implemented outside the speaker enclosure.

20. The system of claim 1, wherein:
the first meta cell includes a tube and a cavity;
the tube is implemented within and opens into the speaker enclosure; and
the cavity is implemented within the speaker enclosure.

21. The system of claim 1, wherein the first meta cell is implemented outside the speaker enclosure and is connected to the speaker enclosure through acoustic coupling.
